(19) United States
(12) Patent Application Publication
(10) Pub. No.: US 2014/0302935 A1
(43) Pub. Date: Oct. 9, 2014

(54) TURN TIMER SYSTEM APPLIED TO A PUZZLE BATTLE GAME

(71) Applicant: DENA CO. LTD., Tokyo (JP)

(72) Inventor: Roger ROYCE, San Mateo, CA (US)

(73) Assignee: DeNA Co. Ltd., Tokyo (JP)

(21) Appl. No.: 13/857,117

(22) Filed: Apr. 4, 2013

(51) Int. Cl. A63F 13/30

(52) U.S. Cl. CPC A63F 13/12
USPC 463/42

(57) ABSTRACT

One or more techniques are employed alone or in combination, in order to improve a video game experience. According to one technique, the time period of a user's turn can be dynamically altered during game play. In another technique, the period of user play can be prolonged, for example by improving a player's odds of success within the game. Still another technique may relate to reducing the amount of time it takes for a user to return to game play after a game application is selected. One or more of these techniques may be used in a video game combining puzzle and battle aspects in a turn-based battle environment that requires the solution of puzzles prior to a battle sequence.

### BACKGROUND

Embodiments relate to the field of video games and methods and systems therefor.

Video games are popular pastime activities. In the past, video games were played on arcade machines, televisions, and computers. More recently, video games are played on portable devices, such as mobile phones and tablets.

The video games that are played on portable or mobile devices are sometimes referred to as “mobile video games.” The portable devices (or mobile devices) typically include a touch sensitive display area (e.g., a touchscreen) whereon players can view videos and input commands.

Some mobile video games allow players to play the games by inputting commands on the touchscreen. Video games that involve matching of icons (e.g., matching of “gems”, “jewels” or tiles) are popular, such as DUNGEON RAID™. Games that involve battle between characters are also popular, such as POKEMON™.

A player input in gem or jewel matching games includes swiping a line through two or more matching gems or jewels. The gems or jewels can be adjacent to each other or side by side. The gems or jewels can be positioned in cells in a geometric pattern, such as a grid or a honeycomb. In some cases, adjacent gems or jewels can share a common cell wall.

A player's finger lifts off the touchscreen at the end of the swiping motion to end his or her turn. Users may tire of this simple and repetitive exercise.

Therefore there is a need for new and varied game features within this basic framework to maintain or increase player interest. Inclusion of puzzle game features in a turn-based battle game contributes additional layers of complexity and can offer increased strategic thinking.

### SUMMARY

Embodiments relate to one or more techniques that may be employed alone or in combination, in order to improve a video game experience. According to one technique, the time period of a user's turn can be dynamically altered during game play. In another technique, the period of user play can be prolonged, for example by improving a player's odds of success within the game. Still another technique may relate to reducing the amount of time it takes for a user to return to game play after a game application is selected. Certain embodiments may find particular use in a video game combining puzzle and battle aspects in a turn-based battle environment that requires the solution of puzzles prior to a battle sequence.

In a first aspect, the disclosure includes as server system that includes a processor; a network interface to receive a request from a client for a video game download; a non-transitory computer readable storage medium having a program for playing a video game that receives inputs from a user. Users may use a touchscreen to provide input to the game. The program includes code configured to display an environment including a puzzle game with tiles that are contained within the cells of a grid. The program further includes code configured to receive input from the player that extends from one tile on the puzzle grid to at least one other matching tile, code configured to remove from display the matched tiles and replacing the matched tiles with new tiles sequentially in the order in which the tiles were matched, and code configured to establish the initial period, of the player's turn as the time to replace matched tiles.

In some instances, this aspect of the disclosure may be practiced with a system including a network; a client having a touchscreen and a communication module; and a server coupled to the client via the network and configured to receive a request from the client for a video game download. The server has a processor, a network interface, and a non-transitory computer readable storage medium. The non-transitory computer readable storage medium has a program for playing a video game that receives inputs from a user. Users may use a touchscreen to provide input to the game.

In an embodiment, the program further includes code configured to receive an additional input that extends from one tile through at least one other matching tile, the additional input completed during the initial period. In some cases, the program includes code configured to receive multiple additional inputs. In addition, the program may further include code configured to prolong the initial period of play based on the time to remove and replace tiles matched from the additional input.

In an embodiment, the program includes code configured to replace matched tiles based on a fixed rate of removing and replacing each tile as each tile is matched in sequential order. The rate of removing and replacing each tile may be applied to a first match as well as to additional matches within a turn.

In an embodiment, the program includes code configured to replace matched tiles based on a decreasing rate of removing and replacing each tile as each tile is matched in sequential order. The rate of removing and replacing each the may be applied to a first match as well as to additional matches within a turn.

In an embodiment, the program further includes code configured to display within the game environment an enemy at a first location and a player character at a second location. In some cases, the magnitude of a player character attack on an enemy is determined by the tiles matched in more than one player input.

In a second aspect, the disclosure includes methods of prolonging a player's turn in a variable manner. Embodiments of the disclosure herein may include methods of displaying an environment including a puzzle game having tiles contained within the cells of a grid, receiving a player input that extends from one tile through at least one other matching tile, removing from display the matched tiles and replacing matched tiles with new tiles in the order in which the tiles were matched, and establishing the initial period of the player's turn as the time for replacing the matched tiles. Additional embodiments of the disclosure may include methods of analyzing player input on the puzzle grid, such as the number of matches made within a turn and the number of gems matched in each swipe; methods of setting an initial turn period based on the parameters associated with the player's initial match, and extending the initial period based on subsequent matches made within the turn period; methods of varying the extended period may include increasing the speed at which tiles are replaced in each successive match, or increasing the rate at which tiles are replaced for each match as the end of the turn approaches; and methods of calculating the extended play period which can be performed in real time in response to the player's input.

In a third aspect, the disclosure includes a server system that includes a processor; a network interface to receive a request from a client for a video game download; a non-transitory computer readable storage medium having a program for playing a video game that receives inputs from a user. Users may use a touchscreen to provide input to the game. The program includes code configured to store the location of play within the program, including the last challenge played and the last stage played within the challenge. The program further includes code configured to receive an input from the user to exit the program; code configured to terminate the program upon receiving the input; code configured to display an option to return to the stored location of play upon selection of the program; and code configured to return the user to the stored location of play when the option to return to the stored location is selected.

In some instances, this aspect of the disclosure may be practiced with a system including a network; a client having a touchscreen and a communication module; and a server coupled to the client via the network and configured to receive a request from the client for a video game download. The server has a processor, a network interface, and a non-transitory computer readable storage medium. The non-transitory computer readable storage medium has a program for playing a video game that receives inputs from a user. Users may use a touchscreen to provide input to the game.

In an embodiment, the program stores the location of play as the beginning of the last challenge attempted by the user. As an alternative, the program may store the location of play as the beginning of the last stage attempted by the user.

In an embodiment, the program further includes code configured to display an environment including a player character. In some cases, the code permits optional revision of the character, or team of characters, before returning the user to the stored location of play.

In yet another aspect, the disclosure includes methods of returning a player to play after exiting the program. Embodiments of the disclosure herein may include methods of storing the location of play within the program, including the last challenge played and the last stage played with the challenge; receiving a player input from the user to exit the program, terminating the program upon receiving the input; displaying an option to return to the stored location of play upon selection of the program; and returning the user to the stored location of play when the option to return to the stored location is selected. Further embodiments may include storing information regarding the player's turn at the time of player exit; processing the input from the player to return to play; and loading the game environment in which the player last played. In some cases, the methods may include allowing additional steps between a player's input, such as the selection or alteration of the player's character or team of characters.

An aspect of the disclosure includes a server system that includes a processor; a network interface to receive a request from a client for a video game download; a non-transitory computer readable storage medium having a program for playing a video game that receives inputs from a user. Users may use a touchscreen to provide input to the game. The program includes code configured to display an environment including an enemy at a first location having a defense parameter, a player character at a second location having special skill, health and type parameters, and a puzzle game having tiles contained within the cells of a grid. The program further includes code configured to receive a player input that extends from one tile through at least one other matching tile; code configured to remove from display the matched tiles and replace matched tiles with new tiles in the order in which the tiles were matched; code configured to analyze the player character, including the special skill, health, and type of the character; and code configured to prolong the player's turn or increase the survival odds of the player's character.

In some instances, this aspect of the disclosure may be practiced with a system including a network; a client having a touchscreen and a communication module; and a server coupled to the client via the network and configured to receive a request from the client for a video game download. The server has a processor, a network interface, and a non-transitory computer readable storage medium. The non-transitory computer readable storage medium has a program for playing a video game that receives inputs from a user. Users may use a touchscreen to provide input to the game.

In an embodiment, the code configured to prolong the player's turn, or to increase the survival odds of the player's character, is executed in response to user input. In some cases, the user input is a purchase, such as the purchase of game currency.

In an embodiment, the code configured to prolong the player's turn, or to increase the survival odds of the player's character, includes code configured to increase the frequency of replacement tiles appearing in the puzzle grid that match the character's type parameter.

In an embodiment, the code configured to prolong the player's turn, or to increase the survival odds of the player's character, includes code configured to increase the frequency of replacement tiles appearing in the puzzle grid, that improve or increase the character's health parameter.

In an embodiment, the code configured to prolong the player's turn, or to increase the survival odds of the player's character, includes code configured to decrease the health parameter of an enemy.

In an embodiment, the code configured to prolong the player's turn, or to increase the survival odds of the player's character, includes code configured to decrease the period between successive availability of a character's special skill.

In a further aspect, the disclosure includes methods of prolonging a player's turn or increasing the survival odds of a player's character by dynamically tuning a game to increase a player's odds. Embodiments of invention include methods of displaying an environment including an enemy at a first location having a defense parameter, and a player character at a second location having special skill, health, and type parameters, and a puzzle game having tiles contained within the cells of a grid; receiving a player input that extends from one tile through at least one other matching tile; removing from display the matched tiles and replacing matched tiles with new tiles in the order in which the tiles were matched; analyzing the player character parameters; and prolonging the player's turn. Embodiments include methods of changing parameters within the enemy zone, the puzzle zone, or the character zone.

### BRIEF DESCRIPTION OF THE DRAWINGS

FIG. 1 shows a simplified view of a communications system.

FIG. 2 shows a simplified view of a server element.

FIG. 3 shows as simplified view of'a user system.

FIG. 4 shows a simplified view of a user device having a touchscreen.

FIG. 5 shows a simplified view of a first zone of a game environment according to an embodiment.

FIG. 6 shows a simplified view of a second zone of the game environment according to an embodiment.

FIG. 7 shows a simplified view of a third zone of the game environment according to an embodiment.

FIGS. 8-10 illustrate potential puzzle matching moves.

FIGS. 11-15 show screen shots of a video game according to some embodiments.

### DESCRIPTION

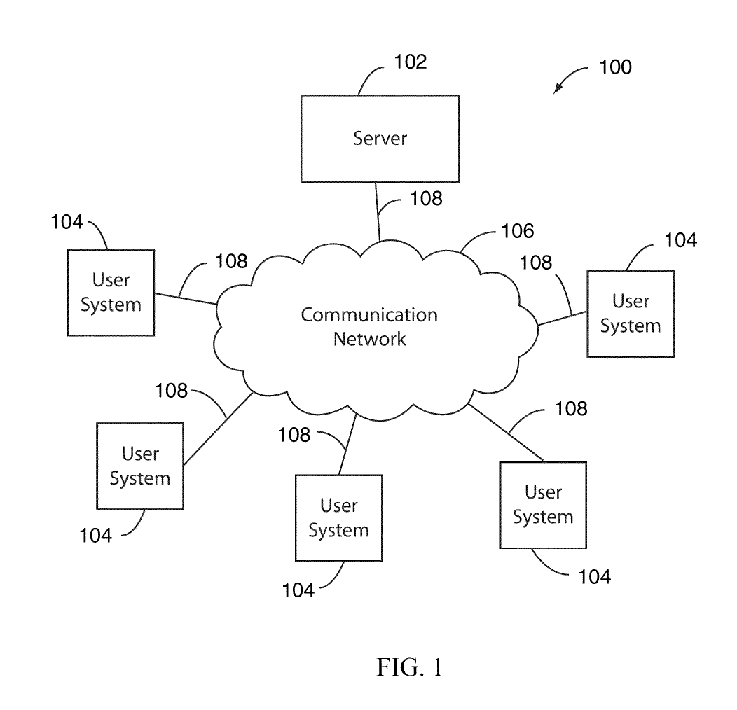

Embodiments of video games as described herein may be deployed on a user device via, a communications system. In particular, FIG. 1 shows a simplified view of a communications system.

The communication system 100 comprises a server 102 which is in communication with a communications network 106 via a communications link 108. FIG. 1 shows a plurality of user systems 104 that are in communication with the communications network via links 108.

Server 102 provides the backend support for playing the video game. For example, server 102 permits the user systems to download the game. The server may send alerts or messages to the user systems. The server ma provide updates to the game. The server 102 may also store user profiles and coordinate play among multiple players.

User systems 104 may be smart phones, tablets, laptops, all-in-one computers, or some other computing device that is suitable for playing video games. The user system may have a screen to display the video and an input device to input commands. Both of these functionalities can be provided by a touchscreen.

Communication links 108 may be of the wired or wireless variety. Similarly, the communications network itself may comprise wired and/or wireless components.

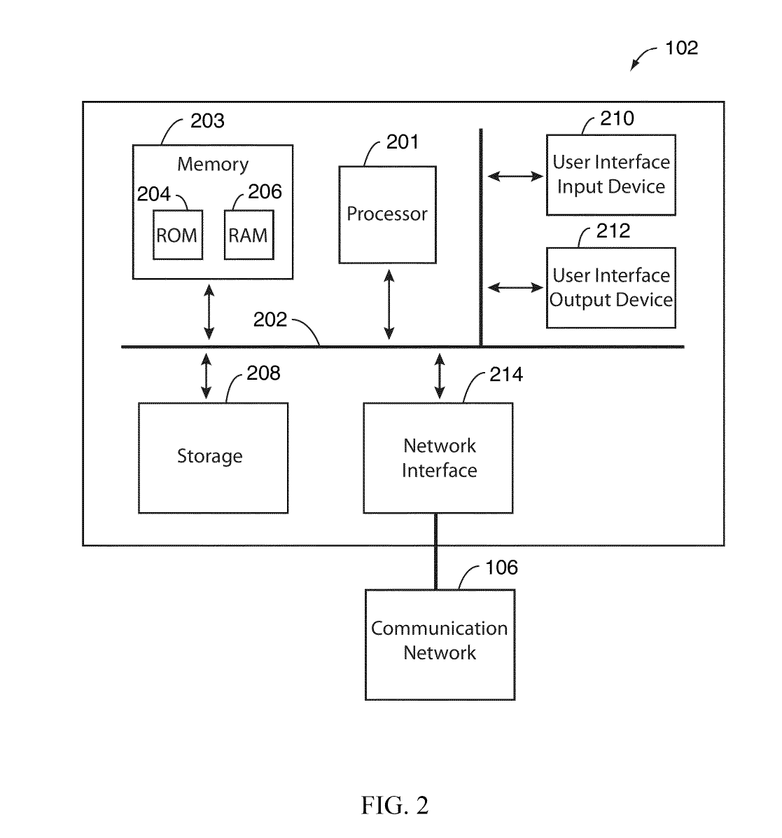

FIG. 2 shows a simplified view of components of server 102. Server 102 comprises a processor or CPU 201 that is in communication with a variety of other elements via a bus 202. Such other components of the server include but are not limited to a non-transitory computer readable storage medium as a memory 203, including a Read Only Memory (ROM) 204 and a Random Access Memory (RAM) 206, and also a higher capacity non-transitory computer readable storage medium 208.

One or more of these components may be employed by the server to store the computer code representing the instructions for operating the video game. This computer code may be sent from the server over the communication network to a user device, to allow a user to download the video game.

An administrator or other authorized personnel ma communicate with the server via a user interface input device 210 (e.g. a keyboard, mouse). For example, the administrator or other authorized personnel ma update or modify the code being disseminated to the various user devices.

The administrator or other authorized personnel ma receive information from the server via a user interface output device 212 such as a display screen. This received information may comprise user registrations and/or subscriptions.

FIG. 2 also shows the server as including, a network interface element 214. This network interface is configured to allow information to be communicated between the server and the communications network. An example of such information is the computer code that is executable on the user system to run the video game.

Although FIG. 2 illustrates the components of server 102, certain user systems 104 may have the same or similar components thereto.

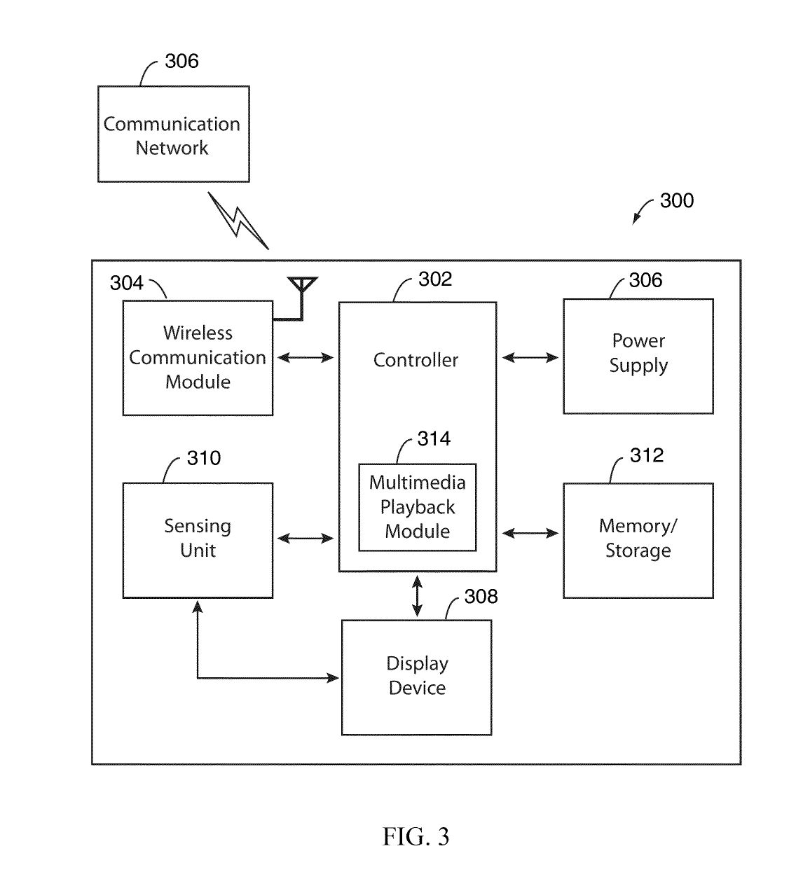

FIG. 3 shows a simplified view of a user device 300 which is a type of a user system 104. User device 300 includes a controller 302 for controlling the operation of the user device, a wireless communication module 304 for communicating with a network, a power supply 306, a display device 308, a sensing unit 310, and a memory/storage unit 312. According, to certain embodiments, user device 300 may be a smart phone or tablet.

Wireless communications module 306 is used to communicate with a wireless network and receive a video game or data tile from server 102. The video game or data file received from the server, is stored in the memory/storage unit 312 using controller 302.

The video game comprises computer code for executing various steps needed to play the video game.

Once the game is downloaded to the storage unit, the user device can play the game without being connected to server 102. Alternatively the game may call for user device 300 using a browser to remain in communication with server 102 to play the game, and/or to receive a key or a portion of the video game each time the user wishes to launch the game.

The video game is launched and played using a multimedia playback module 314. The video game is displayed on display device 308. In one embodiment, display device 308 may be a touchscreen that both displays the game and receives player input. Sensing unit 310 senses inputs, including but not limited to swiping motions made on a touchscreen.

Embodiments of the invention can be practiced in relation to video games, including but not limited to puzzle solving video games, battle-based video games and video games that combine elements of puzzle solving and character battles.

Puzzle solving games can involve swiping a line through two or more gems or jewels that can be matched. For example, gems or jewels of the same shape or color can be matched. Once matched, the gems or jewels are removed from the puzzle grid. The puzzle grid can take the shape of a geometric pattern, such as an orthogonal grid or a honeycomb pattern. In many cases, the gems or jewels that can be matched are adjacent to each other. For example, matchable gems or jewels can share a common cell wall within an orthogonal grid.

In embodiments, matching can be accomplished by tracing a path through tiles. The removed tiles can be replaced by a random assortment of new tiles on the puzzle grid. The terms “swiping”, “tracing” and “matching” are used interchangeably herein. The terms “gems”, “jewels”, “shapes”, “icons”, “tokens” and “tiles” are also used interchangeably.

Battle-based video games can be played with one or more characters that a player can use to battle, or fight, non-player enemy targets or non-player enemy characters. In some embodiments, the players and the non-players may take turns during a battle session.

Video games can combine elements of puzzle solving and character battles. In some embodiments, players must solve puzzles by matching gems or jewels. The matching can precede a character battle, and the nature of the player's matches can determine the ability of the player's characters to battle and defeat enemies.

Embodiments disclosed herein may improve a player's video game experience. For example, a player's turn can be prolonged by a turn timer that increases the duration of her turn. The turn timer can change the period of the rum based on the player's moves or input within the turn, in another example, a video game can prolong a player's turn and improve the player's chances of success within the game. Finally, in some embodiments a player may rapidly return to play after exiting the game application. These improvements will now be discussed further in relation to embodiments of elements of puzzle solving and battle-based video games.

According to an embodiment, a video game may combine puzzle solving and a turn-based battle game. The game can be played on a mobile device such as a tablet or mobile phone. In some instances, the game may be played on laptops, all-in-one computers, or some other suitable computing device.

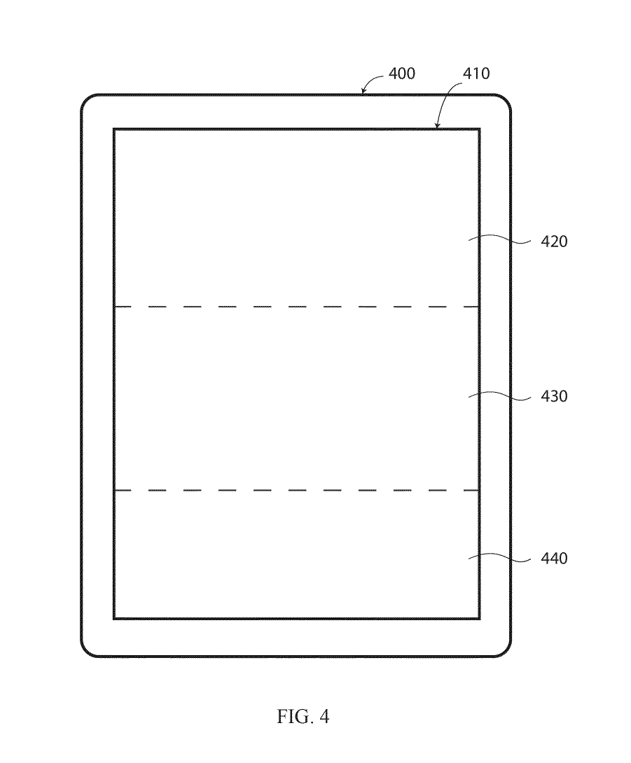

The game may be played on a user system through which a player can input selection commands and/or puzzle play moves. FIG. 4 shows a simplified view of a user device having a touchscreen. Tablet or smart phone 400 has touchscreen 410 that displays a video game of an embodiment of the present invention.

The touchscreen displays video game environment with information that can be divided into zones according to an embodiment of the invention. Examples of such zones can include but are not limited to an enemy zone 420, a puzzle zone 430, and a character zone 440. The zones can be displayed simultaneously.

In some embodiments, more or fewer game zone environments may be displayed. According to particular embodiments, information to be displayed may be reorganized into different zones and displayed in different areas or at different times on touchscreen 410.

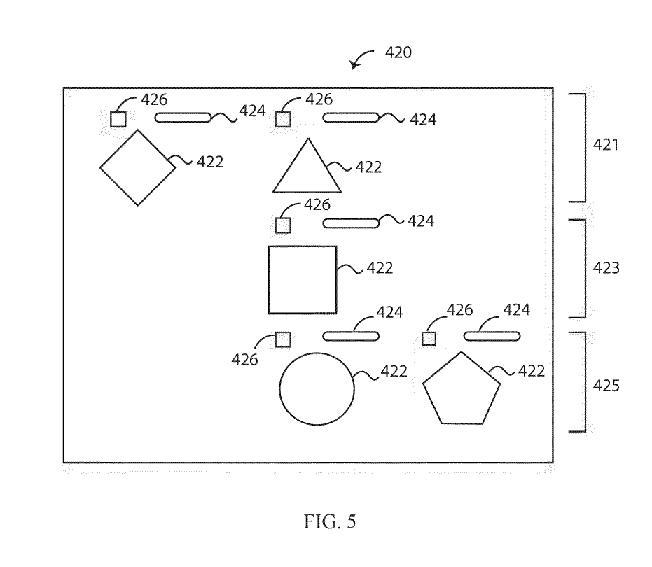

FIG. 5 shows a simplified view of a first zone of the game environment according to an embodiment. Enemy zone 420 includes three rows: 421, 423 and 425. Enemies 422 are arranged in these rows.

In FIG. 5, row 421 includes two enemies, row 423 contains one enemy and row 425 has two enemies. In some embodiments, enemies 422 are primarily static within enemy zone 420 until they are ready to attack.

In some embodiments, enemies 422 may be capable of movement within the environment. For example, enemies 422 may advance vertically downward row by row towards puzzle zone 430 after each player's turn.

When an enemy reaches the row just above puzzle zone 430 (e.g., row 425), it may attack the characters in character zone 440 during its next turn.

After an attack and during the enemy's turn, the attacking enemy may be repositioned vertically upward into row 421 so that it may advance downward, turn by turn and row by row, to attack again. The number of rows in enemy zone 420 is not limited, and additional rows can be added or dropped in accordance with the level of difficulty desired.

Enemies are non-player characters that can be depicted in a variety of shapes, sizes, colors, and/or images. Enemies may be assigned names and profiles.

Profiles may include characteristics such as character name, affinity, grade, type, experience, special skill, skill level, rarity, health points, attack points, and health restoration requirements, as non-limiting examples. In some embodiments, enemies 422 are each depicted with an attribute 426 representing one or more characteristics of each enemy. By way of a non-limiting example, the attribute may be one of five affinities (e.g., fire, water, earth, light and shadow).

Enemies 422 may also be depicted with property 424. Property 424 may reflect a changing characteristic of enemy 422.

By way of an example, property 424 may display the remaining health or strength of an enemy. An enemy's health will decrease as it is attacked by the player's characters until it runs out of health, resulting in its destruction or capture by the player.

In another example, property 424 may reflect an offensive readiness of the enemy. In yet another example, property 424 is a countdown timer indicating the time remaining before the enemy regenerates. Still other examples may include an enemy's grade, experience level, skill level, special skill readiness, rarity, health points, attack points, and health restoration requirements.

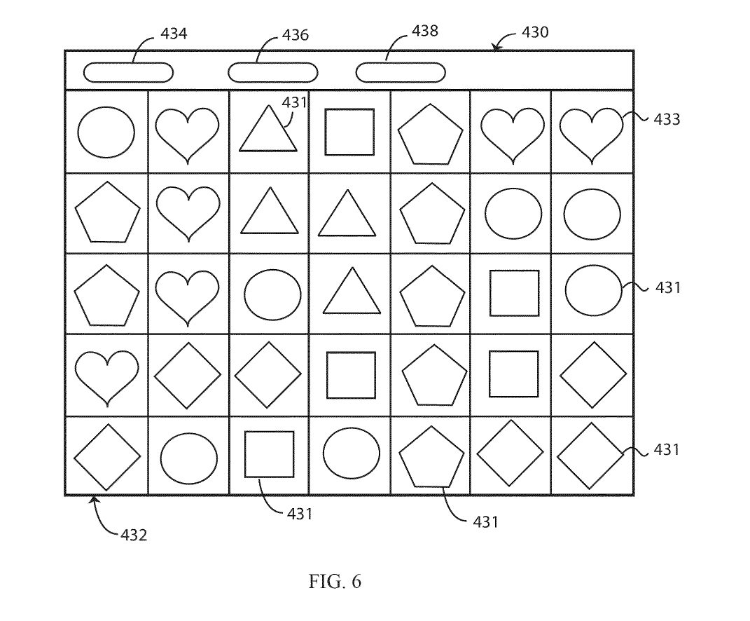

FIG. 6 shows a simplified view of a second zone of the game environment according to an embodiment. Game environment zone 430 includes a puzzle for the players to solve. Game zone environment 430 may include various counters that display information to the player, including but not limited to tile counter 434, high score 436, and enemy capture counter 438.

Grid 432 is illustrated with gems 431 and 433 located between the grid lines. Gems or tiles can vary in shape and color. However in some embodiments, gems of the same shape also have the same color.

In an embodiment, different the shapes represent different affinities. Each tile shape may be assigned a specific color that also corresponds to the different affinities.

On grid 432, gem 433 does not correspond to an affinity and is assigned as different shape and color. Gem 433 may represent a character property, such as health. Matching gems 433 may result in a change to a character property. As a non-limiting example, gems 433 may be red hearts that, when matched, increase the health of the player's characters.

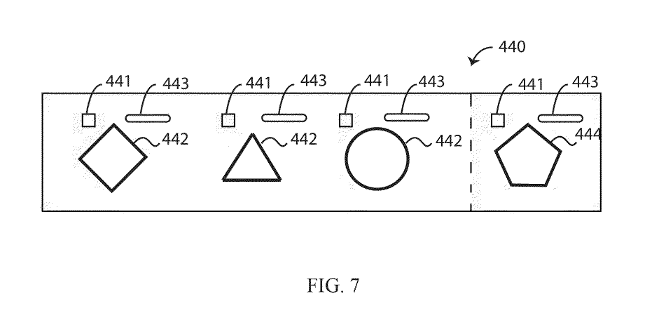

FIG. 7 shows a simplified view of a third zone of the game environment according to an embodiment. Character zone 440 displays the current player's characters 442.

In some embodiments, characters 442 are each depicted with an attribute 441 representing one or more characteristics of each character. In certain embodiments, attributes can be the same attributes 426 assigned to enemies 422.

Attributes of a character and of an enemy can determine a number of aspects of game play, and in particular the effectiveness of attacks between that the character and enemy. By way of a non-limiting example, the attribute may be one of five affinities (e.g. fire, water, earth, light, and shadow).

The affinity assigned to a character can determine its effectiveness against an enemy. For example, an attack by an earth character against a water enemy will be more effective than its attack against a fire enemy.

Similarly, the affinity assigned to an enemy will determine its relative ability to withstand an attack. For example, a fire enemy will more readily withstand an attack from a fire character, but will be lose more health from the same attack from a water character.

According to various embodiments, a character's attribute, such as affinity, may be indicated by displaying a shape or symbol common to the attribute in character zone 440. In certain embodiments, a character's attribute, such as affinity, may be indicated by a specific color common to the attribute. In some embodiments, both a symbol and color are displayed to indicate a character's attribute, such as affinity.

Within character zone 440, characters 442 may also be depicted with property 443. Non-exclusive examples of properties include grade, experience level, skill level, special skill readiness, rarity, health points, attack points, and health restoration requirements.

In many embodiments, a character's property may be indicated by displaying numerical counters or non-numerical meters (such as a bar) near the character depiction. Certain properties such as special skill readiness or critical health status can be indicated by modifying the display of character 442. Examples of modified display includes, for example, flashing character icons, glowing character icons, glowing frames around characters, backlighting, or highlighting of character icons.

Character zone 440 may include a special character 444 displayed in a manner consistent with the display of characters 442 with respect to attribute 441 and property 443. Special character 444 is a player's character that is shared by another player, or is borrowed from another player. Inclusion of such a character in character zone 440 is optional.

Play commences with the player's selection of a “team” of characters, which may include borrowed or shared characters. On being, presented with the type and profiles of various available characters, the player selects the character by tapping the touchscreen.

After the player's team is selected, play may begin. Game play takes place in a series of challenges, each of which may include multiple game stages. Typically, a player defeats the enemies in each stage in order to conclude the challenge before moving onto the next challenge.

Each stage within a challenge may increase in difficulty until a final stage is reached. The final stage may present a “boss enemy”, “guardian monster”, or other non-player character that is more difficult to defeat. Upon the start of a challenge, enemy zone 420, puzzle zone 430 and character zone 440 are loaded and turn based play commences.

During the player's turn, the player makes a move in the puzzle zone by tracing an unbroken path through two or more tiles of the same color. The matched tiles are then removed from grid 432. The tiles can be removed in the order in which the tiles were matched, and new tiles are randomly inserted into the cleared positions.

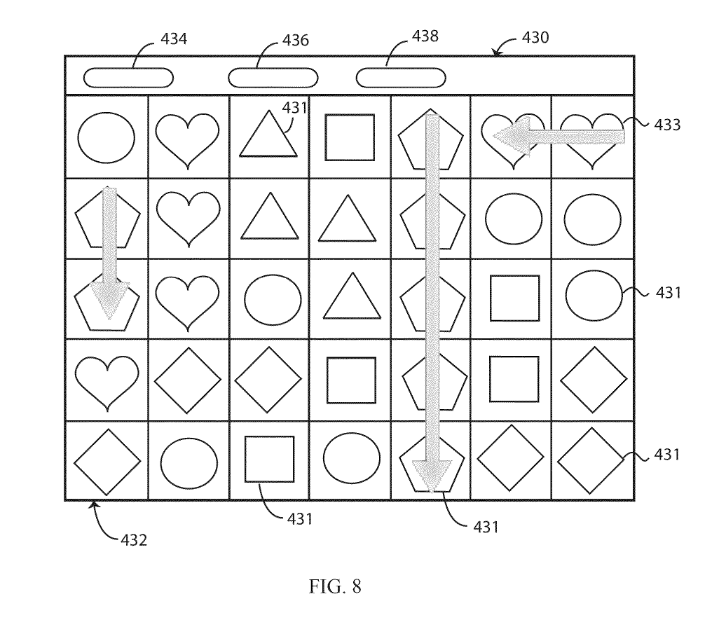

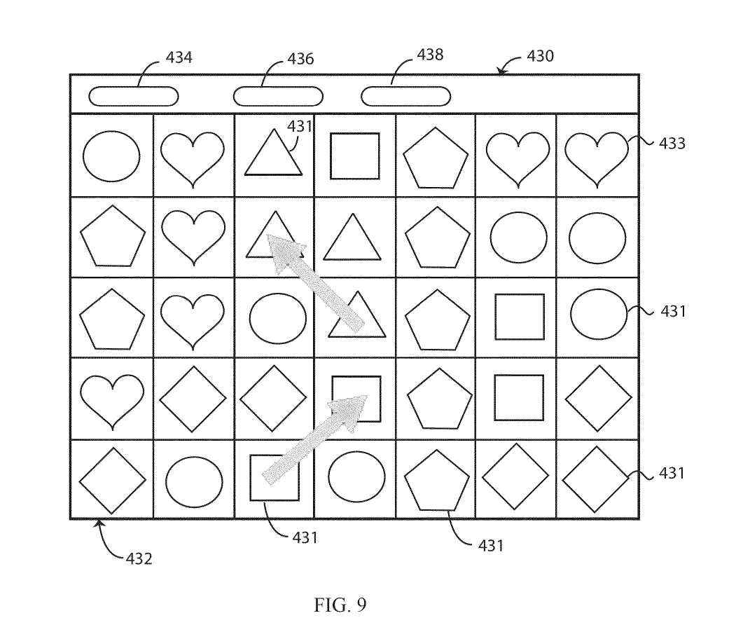

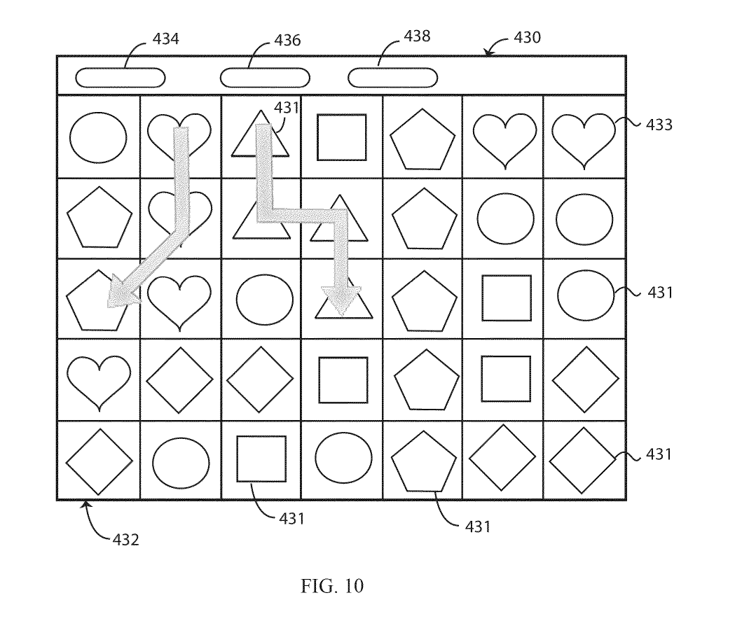

In some embodiments, grid 432 is orthogonal and matching two or more icons must be performed horizontally or vertically as in FIG. 8. Matching two or more icons may, in various embodiments, further include diagonal movement as shown in FIG. 9, or a combination of movements as shown in FIG. 10. A path may be retraced to undo a player's move.

In many turn-based puzzle-based games, players are limited to a single move in a turn. For example, only one icon might be moved, in a turn, or a single swipe completed. In accordance with particular embodiments, more than one move or match can be made within a player's turn.

Once the matches are completed, the player's characters that correspond to the matched gems are given attack points. For example, if red tiles representing an affinity are matched, the player's red-colored characters with that affinity receive attack points.

Attack points that are calculated based on variables that may include but are not limited to: base damage against an enemy having given attributes and properties, the number of tiles removed, the maximum length of matched sequences, successive clearance of the same tile, and the total number of matches. The attack points may be displayed temporarily as properties 443 in the character zone prior to attack. Once the attack has been made, the attack points may be removed from display.

When more than one enemy appears in the enemy zone, a player can designate one or more enemies to be attacked by tapping on the enemy selected for attack.

After the attack by the characters, enemies 422 receive damage that corresponds to the attack points. If the amount of attack points exceeds an enemy's health, the enemy is defeated, and optionally may be captured as a potential team member for the winning player.

Attacks may be modified by a variety of inputs from the players. As non-limiting examples, a match of a certain number (for example, five) or more symbols in the puzzle zone, permits all characters on a player's team to attack in a group attack. Alternatively, a match of five or more symbols may allow a single character to attack all enemies in the enemy zone. Additional attack features may be designed to be triggered by a match of a certain length.

After the player's turn, an enemy may attack and the player's characters may receive damage in accordance with a formula calculated using the given attributes and properties of the player's characters. The total health of the team members may be displayed in a group metric, or each individual character's health may be displayed as properties 443. Upon receiving an attack, a player may restore the health of damaged characters by successful matching of healing or restoration tiles in the next turn.

In many embodiments, the player may continue to play the game indefinitely until the health of the player's team as a whole, or all team members, is reduced to zero. At such time, the game ends.

In addition to basic play, a player may purchase game currency in a separate transaction. Game currency may be used to for a variety of purposes.

As non-limiting examples, game currency may be used to: increase the number of characters a player can add to his team; to increase the stamina of one or more of the player's characters; to continue a game after being defeat by non-players; and to purchase or to summon new characters with additional strength or abilities. Additional features can be unlocked after player purchase.

In many turn-based puzzle-based games, preset conditions limit the amount of play that can be achieved by a player during a turn. For example, in some cases, a player is limited to a single move during the player's turn. Thus, a player can only make one match, or take one swipe, in the course of his or her turn, which has the potential to slow down play.

In more fast-paced games, a timer is activated at the start of a turn. Thus the player has a fixed amount of time to start and finish a move by making a match or by ending a swipe, after which the timer is reset.

In some embodiments, matched tiles are removed from the puzzle grid sequentially in an order that follows the traced path of each move. The amount of time to remove each tile may be fixed initially so that the time to remove four tiles (for example) is twice the amount of time to remove two tiles.

Once a tile is removed, it is replaced with a new tile. Therefore replacement tiles also appear sequentially in an order that follows the traced path of the player's move.

In one aspect, an embodiment includes a video game with a turn timer limits the amount of time for a player's turn, during which a player can make one or more matches.

When the tiles from the last move are removed before the next move is started, or finished, the turn ends. The amount of time in a player's turn, however, may be altered by variables that can include the number of matches played during a turn and the rate at which tiles are removed after they are matched. Thus the time allowed for as player's turn can be determined dynamically in response to player input during as turn.

Players that continue to make one or more successive matches will extend their play by staying ahead of the turn timer. The game thus offers additional strategic play and permits players to increase the number and frequency of matches to make progress in the game.

In an embodiment, the duration of a turn may be based on the time to sequentially replace the tiles in a first match by the player. The time turner may be configured such that the player can make one or more matches during the time established b this initial match.

Players that make moves slowly, or make matches with fewer objects, may thus be limited to only one match within a turn as the time to replace tiles in the initial match expires before a second match can be made. Skillful players, on the other hand, can make multiple moves within a turn.

In an embodiment, the turn timer may limit an initial amount of time in a turn to the time it takes to remove tiles from a puzzle grid after a single move or swipe. The time turner may subsequently increase the initial period after a second successive match is made within the initial period.

The turn period can be increased again after each subsequent successful match beyond the second. The amount of time of each extension may be a fixed amount for each successful match.

In some cases, the amount of time may depend on the amount of time to replace removed tiles in a sequential manner. In such cases, the length of an extension is greater for longer matches.

The number of increases granted within a turn may be limited as desired. For example, time increases may be limited to the first five, ten or twenty successive matches.

As another example, time increases may be granted only after every other successive match. In yet another example, fixed or variable time increases may be periodically granted at fixed intervals so long as the player's turn has not ended. A further example includes allowing increases only for matches for a certain number of tiles matched, such as providing time turner increases only when five or more tiles are matched in a swipe.

In a further embodiment, the video game includes a turn timer that extends the length of play after each successive match within a turn, but the length of each extension may vary. In some cases, the length of each successive extension can be changed by increasing the speed at which tiles are replaced in each successive match.

In particular cases, the rate at which tiles are replaced for each match increases as the end of the turn approaches. For example, if a player makes five successive matches of three tiles within a turn, the extension of time for the last match is less than that of the first match. Tiles may be removed more slowly at first, but then the velocity of the clearance and replacement speeds tip as the turn continues.

Additional embodiments may include methods of prolonging a player's turn through a variable turn timer. Methods can include analyzing player input on the puzzle grid, such as the number of matches made within a turn and the number of gems matched in each swipe.

Methods may include setting an initial turn period based on the parameters associated with the player's initial match, and prolonging the initial period based on subsequent matches made within the turn period. Additional methods of varying the extended period may include increasing the speed at which tiles are replaced in each successive match, or increasing the rate at which tiles are replaced fix each match as the end of the turn approaches. Methods of calculating the prolonged play period may be performed in real time in response to the player's input.

In many turn-based puzzle-based games, players and non-players take turns as players continue to progress through the game so long as the player's characters remain undefeated. A player may need to quit and exit a game either during a game challenge or between stages to turn to other tasks. Players may also need to pause a game during play to attend to other matters. Thus in many instances, players are allowed to pause a game or to exit a game, typically by choosing such options.

Often, once a player exits a game, the player must progress through multiple menus to return to the stage or challenge last played. For example, each time a game is started, a player may be presented with a maw menu offering choices of types of game play.

Once a type of game play is chosen, the player may be asked if she wishes to view a demonstration or a tutorial. The player may be further asked where within a challenge she wishes to be placed. Thus, the player may be burdened with remembering the challenge and/or stage in which she was playing when she quit the game.

In some cases, menus require additional motions (such as scrolling) to access menu options. These additional steps can frustrate players having a limited amount of free time.

In one embodiment, upon loading of the video game an option is offered to return to play where the player last stopped or exited. A player's experience can be improved by bypassing undesired menu options. The time between the selection of the game application and starting play at the last-played location in the game is reduced.

In some embodiments, the return to play option is a single menu selection that returns to the player to the beginning of the last challenge played. The game may recall the last challenge played for a given player. The player does not have to remember this information, which also improves her game experience.

In some cases, the player will be returned to the beginning of the last challenge played with the same characters.

In some cases, the player will be provided with an opportunity to change characters before being returned to the beginning of the last challenge played.

In some embodiments, the return to play option is a single menu selection that returns to the player to the stage within a challenge that was last played. In some cases, the player will be returned to the stage played with the same characters.

In some cases, the player will be provided with an opportunity to change characters before being returned to the last stage played. The game may be configured to return the player to the beginning of the last stage attempted, or to the exact point within the stage at the time the player quit.

In some embodiments, a video game allowing multiple player profiles will ask the player to indicate his or her profile. After this, the return to play option is presented.

In further embodiments, once the game is selected, a player is returned to play at the stage when the player exited. In such cases, no menu selection is necessary. The player is returned to play immediately after the game application is selected.

Additional embodiments may include methods of returning a player rapidly to play. Methods may include but are not limited to: storing information regarding the player's turn at the time of player exit; processing the input from the player to return to play; and loading the game environment when the player last played.

Embodiments include methods that allow additional steps between a player's input, such as the selection or alteration of the player's character or team of characters. Such methods may return the player to the last challenge played, or to the stage of the last challenge played.

In some embodiments, a player may return to play with a single menu selection, two menu selections, or three menu selections. In some embodiments, a player may return to play with one touchscreen tap, two touchscreen taps, or three touchscreen taps.

A player presented with the return to play option, may also be presented with one or more of the following options: to select a type of game play if appropriate; to manually select game stages; to view demonstrations or tutorials; to make changes to the player's characters; to change player profile information; or to otherwise move through game menus.

In many video games players who are defeated, or whose game otherwise comes to an end, may be able to prolong play by buying more playing time. In arcades, for example, players can insert quarters or tokens in return for continuing play. Similarly, in computer-based games, players can separately purchase game currency that can be used for multiple purposes, including prolonging play time.

In many turn-based puzzle-based games, the player's team may be defeated by a stronger enemy force. In such cases, prolonging play time may or may not allow a player to move to the next stage.

If a player cannot overcome an enemy, prolonging play does not result in the player's goal of finishing the stage and moving onto the next challenge. In this manner, a player may be discouraged from purchasing extended play.

According to one embodiment, a video game includes dynamic tuning to increase a player's odds. Dynamic tuning can be a game feature which may be purchased by a defeated player, or may be purchased by a player who desires to make play easier before she experiences defeat.

Dynamic tuning may be designed such that a player is unaware of the mechanism by which her odds are improved. Thus users can choose improve their odds of succeeding in each stage of the game. Mechanisms for improving such odds can be non-user facing, so that the player unconsciously feels comfortable during play.

In some embodiments, dynamic tuning can increase a player's odds by changing the puzzle grid. As an example, as tiles are replaced after matches, replacement tiles can be presented that are more favorable to a player.

Dynamic tuning may increase the frequency at which recovery or health tiles appear on the puzzle grid so that a player's characters can heal more often or more quickly.

Dynamic tuning can increase the frequency at which fire tiles appear on the puzzle grid when the player's strongest team character is a fire character. As another example, dynamic tuning may slow down the rate at which tiles are replaced, giving the player more time to make multiple matches within a turn.

In yet another example, dynamic tuning may result in longer potential matches that provide the player's character with additional attack strength. In yet another case, special tiles may appear that, when played, provide additional attack strength or special attack features.

In embodiments, dynamic tuning can increase a player's odds by changing the enemies that face the player. For example, dynamic tuning may lower an enemy's defense parameter so that the enemy may be more easily defeated.

In another example, dynamic tuning can deliver enemies to the enemy zone with attributes that are more susceptible to defeat by the player's team. In some examples, dynamic tuning can deliver fewer enemies to the enemy zone.

Similarly, dynamic tuning can deliver enemies to the enemy zone with properties that are more susceptible to defeat by the player's team. Examples can include but are not limited to lower health, lower experience, and/or lower recovery rates.

In some embodiments, dynamic tuning may increase the odds by changing the player's characters. As non-limiting examples, after purchase of dynamic tuning, specialized attacks available to a player's character may be used with increasing frequency. Dynamic tuning can temporarily improve the team's health, recovery, and/or attack strength.

Additional embodiments may include methods of dynamically tuning a game to increase a player's odds. Methods can include changing parameters within the enemy zone, the puzzle zone, or the character zone, or combinations thereof.

Embodiments may be more understood through reference to the following EXAMPLES. These are provided by way of illustration, and are not intended to be limiting of the disclosure.

### EXAMPLES

### Example 1

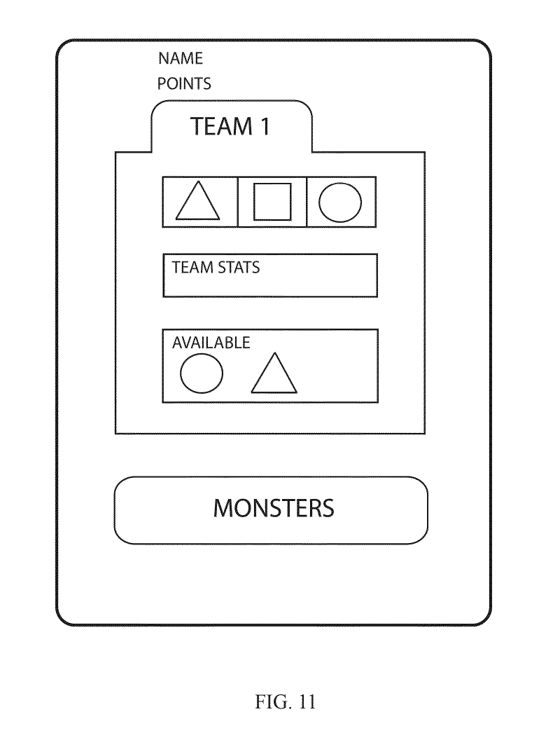

FIG. 11 is a schematic of an embodiment. The top of the screen shows the player's name and the number of points accumulated.

The player's selected team of characters appears in the first tab of the window. The team of characters includes a fire (triangle) character, a water (square) character, and a light (circle) character.

Each character has an identical grade and level, but have different stars that can represent evolution status (not shown). The statistics of the collective team, including health points, can be displayed in the window.

Players may replace characters by removing the team members and choosing from the available characters below, in this case another fire or another light character. The player's characters may be evolved with the deduction of accumulated points or boosted with the payment of game currency. The player can choose to buy or summon monsters by selecting on the “MONSTERS” tab and spending game currency.

### Example 2

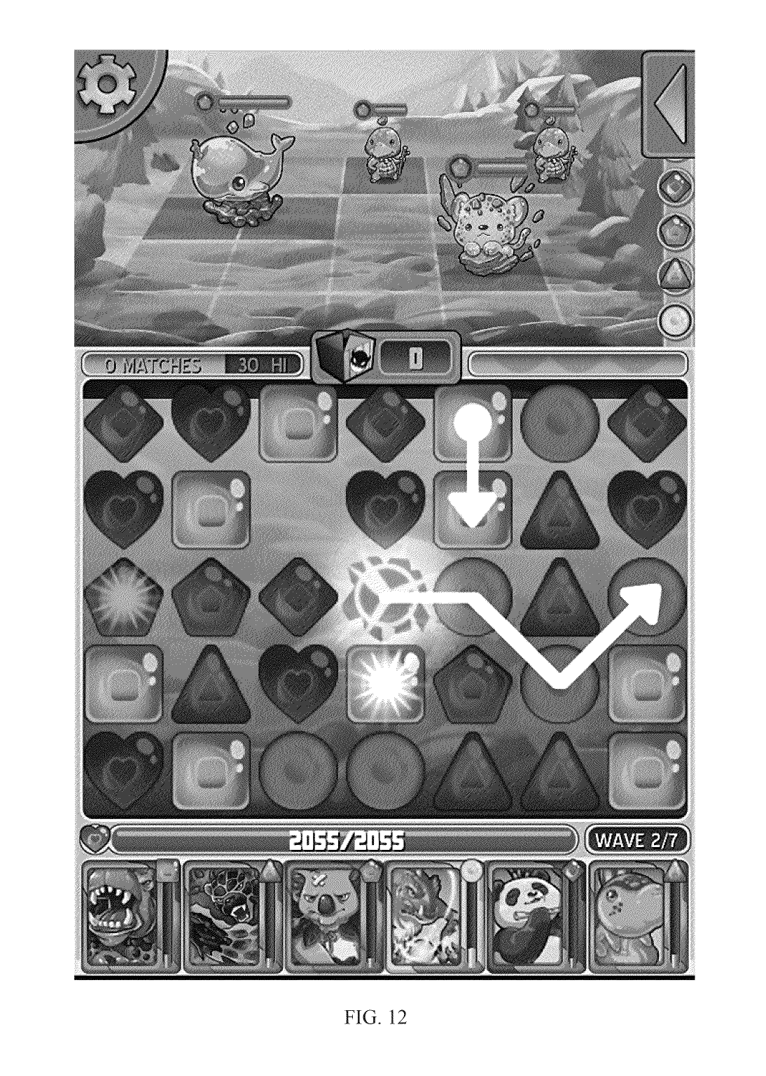

FIG. 12 depicts a game environment of an embodiment. Puzzle zone 430 is displayed below enemy zone 420. Character zone 440 and the character team health meter are located below puzzle zone 430.

The number of stages, also called waves, in this challenge is shown in the lower right hand corner of the screen. The bars alongside each character on the team indicate the number of turns that need to pass before the character's special skill can be used. The frame around each character may blink or flash to show that the special skill can be used.

FIG. 12 shows two moves made by the player of a match of four circles and a match of two squares. The team characters associated with squares and circles receive attack points for the matches.

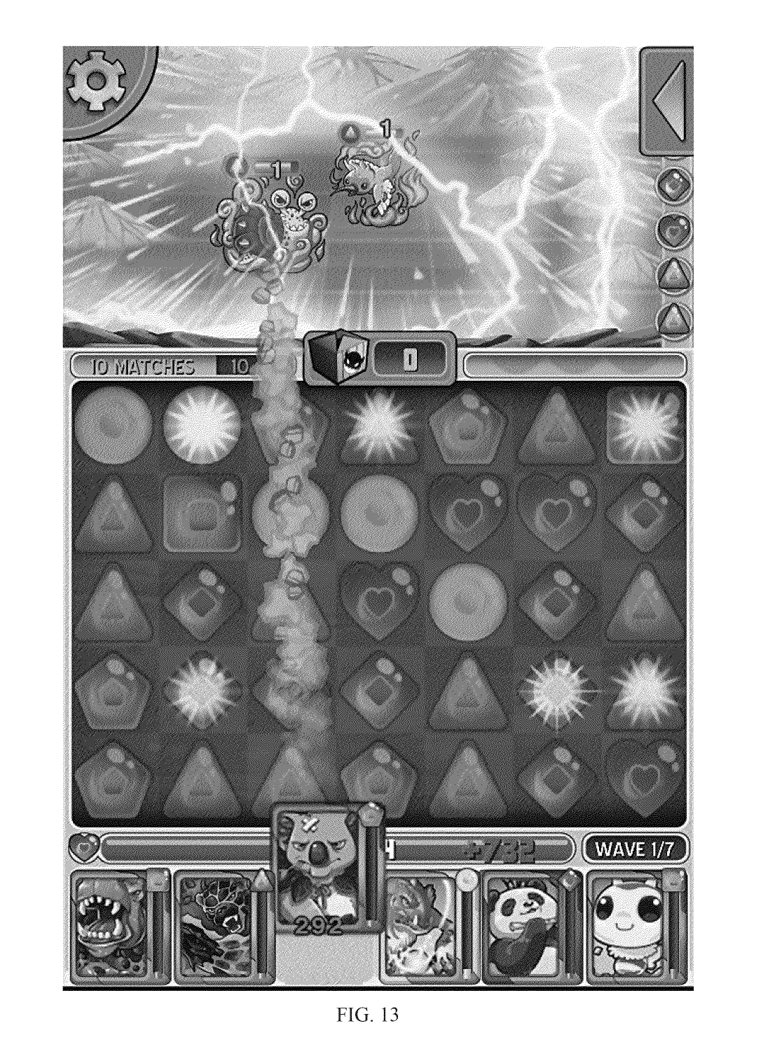

FIG. 13 illustrates an attack by a character receiving points from matched pentagons. If the number of attack points (e.g., 292), exceeds the enemy's defense points, the enemy is defeated. The defeated enemy may be captured and made available as a character for the player's teams.

### Example 3

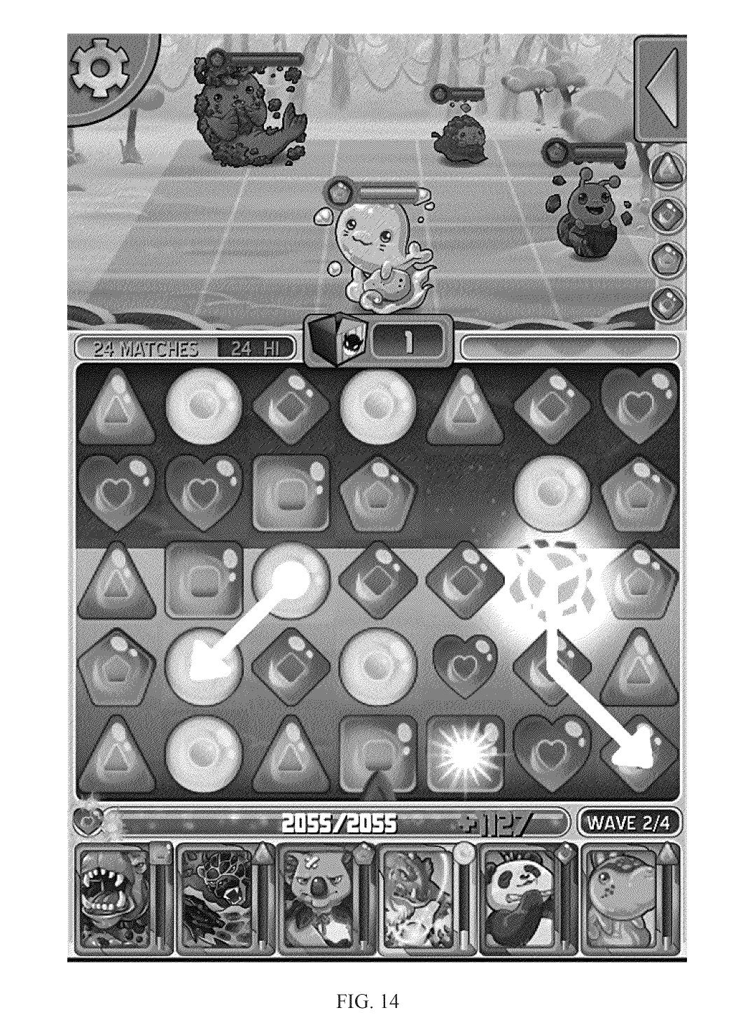

FIG. 14 illustrates a player's matching sequence and an enemy positioned to attack after the player's turn ends. The enemy attack may reduce the collective health of the team from a point total of 2055. The player may restore the lost health points subsequently by matching heart tiles.

In addition to the heart tile, every gem or the may develop into a special gem that, when matched, provides an additional game feature. Examples of such additional game features may include but are not limited to: prolonging the turn, freezing the turn timer for a period, or exploding in different directions.

Tiles that do not correspond to characters on a team may be included on the puzzle grid. However, these tiles may have no effect when matched.

### Example 4

After a challenge is completed, a player can be taken to a results page. Monsters defeated in the last challenge will be displayed, as well as the experience and monster points earned during the last challenge.

Special skills or “power ups” earned from winning the last challenge, can be displayed here. “Power ups” may be used to modify the game, such as slowing down the initial speed of the turn timer, reshuffling the puzzle board, swapping tile colors, and altering attack or defense values for example.

### Example 5

Characters may be borrowed from friends and used on a player's team as an ally that also battles the enemy. The player receives points if a companion is selected to join the team. Points may be used for a variety of purposes, such as making more friends to gain access to additional companions. Players may send requests for friends and companions.

### Example 6

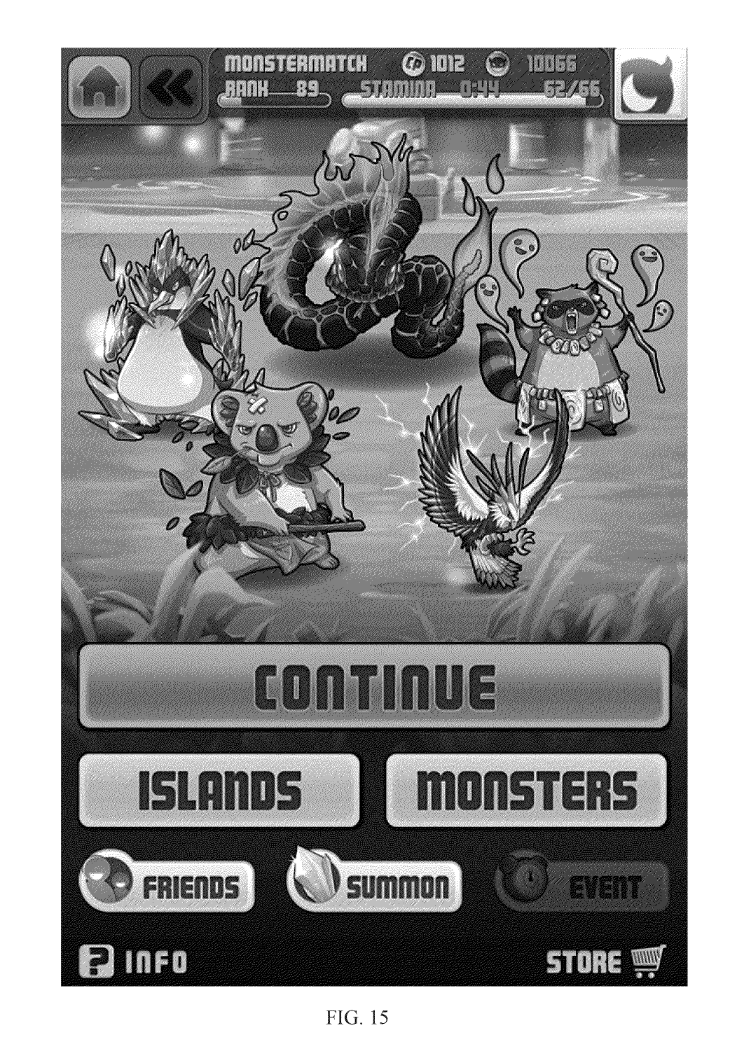

Players may select the game application to initiate the game. After this selection, FIG. 15 is presented.

By selecting the MONSTERS button, the player is taken to a screen displaying the team characters that were last used. The player may modify the team. By selecting ISLANDS, the player is taken to a screen displaying the different challenges available for play. By selecting CONTINUE, play will immediately begin at the start of the last stage that the player attempted before exiting the game.

Having thus described exemplary embodiments, it should be noted by those skilled in the art that the disclosures within are exemplary only, and that various other alternatives, adaptations, and modifications are possible. Accordingly, embodiments are not limited to the specific structures or methods as illustrated and taught herein.

1. A server system comprising:
a processor;
a network interface to receive a request from a client for a video game download; and
a non-transitory computer readable storage medium having a program for playing a video game that receives inputs from a user, the program including code configured to,
display an environment including a puzzle game having tiles contained within the cells of a grid;
receive a player input that extends from one tile through at least one other matching tile;
remove from display the matched tiles and replace matched tiles with new tiles in the order in which the tiles were matched; and
establish the initial period of the player's turn as the time for replacing the matched tiles.

2. The server system of claim 1 wherein the program further includes code configured to receive an additional input that extends from one tile through at least one other matching tile, the additional input completed during the initial period.

3. The server system of claim 2 wherein the program further includes code configured to prolong the initial period based on a time to remove and replace tiles matched from the additional input.

4. The server system of claim 1 wherein the time to remove and replace matched tiles is based on a fixed rate of removing and replacing each tile as each tile is matched in sequential order.

5. The server system of claim 3 wherein the time to remove and replace matched tiles is based on a fixed rate of removing and replacing each tile as each tile is matched in sequential order.

6. The server system of claim 3 wherein the time to remove and replace matched tiles is based on a decreasing rate of removing and replacing each tile as each tile is matched in sequential order.

7. The server system of claim 2 wherein the code configured to display an environment is further configured to display within the environment an enemy at a first location and a player character at a second location.

8. The server system of claim 7 wherein the code is further configured to display a player character attack on an enemy and to display the magnitude of the attack based on the number of the tiles matched in more than one player input.

9-11. (canceled)

12. A system comprising:
a network;
a client having a touchscreen and a communication module; and
a server coupled to the client via the network and configured to receive a request from the client for a video game download, the server having a processor, a network interface, and a non-transitory computer readable storage medium,
wherein the non-transitory computer readable storage medium has a program for playing a video game that receives inputs from a user, the program including code configured to,
display an environment including an enemy at a first location having a defense parameter, and a player character at a second location having special skill, health, and type parameters, and a puzzle game having tiles contained within the cells of a grid;
receive a player input that extends from one tile through at least one other matching tile;
remove from display the matched tiles and replace matched tiles with new tiles in the order in which the tiles were matched;
analyze the player character parameters; and
prolong the player's turn.

13. The system of claim 12 wherein the program includes code to increase the frequency of replacement tiles appearing in the puzzle game grid that match the character's type parameter.

14. The system of claim 12 wherein the program includes code to increase the frequency of replacement tiles appearing in the puzzle game grid that improve the health of the character.

15. The system of claim 12 wherein the code to prolong a player's turn includes code to decrease the health parameter of an enemy.

16. The system of claim 12 wherein the code to prolong a player's turn includes code to decrease the period between successive availability of a character's special skill.

17. The system of claim 12 wherein the code to prolong a player's turn is executed in response to user input.

18. (canceled)

19. A method of playing a video game, the method comprising:
storing the location of play within the program, including the last challenge played and the last stage played with the challenge;
receiving a player input from the user to exit the program;
terminating the program upon receiving the input;
displaying an option to return to the stored location of play upon selection of the program; and
returning the user to the stored location of play when the option to return to the stored location is selected.

20. (canceled)
